(19) United States
(12) Patent Application Publication
(10) Pub. No.: US 2020/0045793 A1
(43) Pub. Date: Feb. 6, 2020

(54) LED EMERGENCY LIGHT

(71) Applicants: Austin Lai, Taichung City (TW); CHI-I LAI, Taichung City (TW); CHUN-YU WU, Taichung City (TW)

(72) Inventors: Austin Lai, Taichung City (TW); CHI-I LAI, Taichung City (TW); CHUN-YU WU, Taichung City (TW)

(73) Assignee: AVERTRONICS INC., Taichung City (TW)

(21) Appl. No.: 16/052,497

(22) Filed: Aug. 1, 2018

(51) Int. Cl. H05B 33/08; H02H 7/18; H05B 37/02; H02J 7/00; G08B 5/36

(52) U.S. Cl. CPC H05B 33/0854; H02H 7/18; H05B 37/0218; H02J 2007/004; H02J 7/0068; G08B 5/36; H02J 2007/0037; H02J 7/0029

(57) ABSTRACT

An LED emergency light may comprise a controller, an LED light, a battery set, a transformer, and a circuit breaker. The controller has an input end and an output end which are respectively electrically connected to the transformer and electrically connected to the battery set and LED light. Also, the LED light is electrically connected to the battery set while the transformer is electrically connected to a power supply and the circuit breaker. The controller is electrically connected to a dynamic sensor configured to detect movements of objects in a preset detecting area and to coordinate with the controller, thereby generating on/off light signals to the LED light. The LED light can be powered by the power supply in normal condition and powered by the battery set when the power supply is cut, which simplifies the control circuit and provides lighting when detecting objects and when emergency.

### FIELD OF THE INVENTION

The present invention relates to a light apparatus and more particularly to a high-service-time LED emergency light with different lighting modes.

### BACKGROUND OF THE INVENTION

Generally, an emergency light is a battery-backed lighting device which is usually installed near emergency exit or evacuation passage of a building, and the emergency light is configured to switch on automatically when the building experiences a power outage.

However, the conventional emergency light is disadvantageous because: (i) the emergency light only works when the power of the building failures, and because of this lower utilization, battery of the emergency light are prone to damage, which leads that the emergency light is out of function when emergency; (ii) the main reason for the high failure rate of the battery is that the power will not be cut off when the battery is fully charged, and, at that time, the battery are configured to be charged and self-discharging small amount of electricity simultaneously, leading to the failure of the battery after a long period and reduce the service life of the battery; (iii) since the emergency light will only be turned on when emergency, a user cannot directly see whether the emergency light is damaged or not, and it is often found that the lights cannot be turned on during fire safety inspection or emergency; (iv) on the other hand, when the emergency light is used, the battery may be short of power or a transformer of the emergency light, which is used to convert AC to DC, becomes power consumption load, resulting in a sharp reduction in the lighting time. Therefore, there remains a need for a new and improved design for an LED emergency light to overcome the problems presented above.

### SUMMARY OF THE INVENTION

The present invention provides an LED emergency light which comprises a controller electrically connected to a dynamic sensor which is configured to detect movements of objects in a preset detecting area. Moreover, the controller is adapted to coordinate with the dynamic sensor to generate on/off light signals. Also, the controller has an input end and an output end. An LED light is electrically connected to the output end of the controller, and the controller is configured to send on/off light signals to the LED light, thereby controlling the on/off operation of the LED light. A battery set is electrically connected to the output end of the controller at one end and electrically connected to the LED light at the other end. A transformer is electrically connected to the input end of the controller at one end and is electrically connected to a power supply at the other end, and the power supply is adapted to provide alternating current (AC) to the transformer. A circuit breaker electrically connected to the transformer is configured to enable electrical current to pass through the transformer when AC is provided from the power supply, and the transformer is adapted to convert AC to direct current (DC) so as to provide power to LED light and to charge the battery set. In addition, the circuit breaker is configured to interrupt electrical current passing through the transformer when the power supply is adapted to not provide AC, and the controller is configured to enable the battery set to directly provide power to the LED light.

In one embodiment, the dynamic sensor has a camera and at least an infrared lamp, and the camera is configured to capture movements of objects in the detecting area, and the infrared lamp is adapted to provide additional illumination when the light in the detecting area is insufficient.

In another embodiment, a battery management system (BMS) electrically connected between the output end of the controller and the battery set is configured to protect the battery set from overcharging and over-discharging.

In still another embodiment, the controller is electrically connected to a photoresistor which is configured to detect the light intensity of the detecting area.

In a further embodiment, the controller, the battery set, the transformer and the circuit breaker are installed in a box, and at least a lamp cover extended outwardly from the box is adapted for installing the LED light.

In still a further embodiment, the controller is electrically connected to a smoke sensor through a wire which is extended out of the box.

In an advantageous embodiment, the controller is electrically connected to a control panel which is installed on a surface of the box.

Comparing with conventional LED emergency light, the present invention is advantageous because: (i) the input end of the controller is electrically connected to the transformer while the output end thereof is electrically connected to the battery set and the LED light, and also the LED light is electrically connected to the battery set while the transformer is electrically connected to the power supply and the circuit breaker, and the dynamic sensor of the controller is configured to detect movements of objects in the preset detecting area such that the LED light can be powered by the power supply in normal condition and be powered by the battery set when the power supply is cut, which simplifies the control circuit and provides lighting when detecting objects and when emergency; (ii) in case that the power supply stops supplying AC power, the circuit breaker is configured to interrupt electrical current passing through the transformer and to make the transformer open circuited, and the controller is configured to wake the battery set so as to enable the battery set to directly power the LED light; (iii) when the transformer is open circuited, the battery set has no need to provide power to the transformer, and the dynamic sensor is selectively turned on, which extends the service time of the battery set; (iv) after the battery set is fully charged, the controller is adapted to stop charging the battery set, and the BMS electrically connected between the battery set and the controller is configured to turn the battery set into sleep mode; and (v) with the dynamic sensor, the LED light is turned on when an object passing through the detecting area, which enables a user to ensure the expected function of the LED light at any time.

### BRIEF DESCRIPTION OF THE DRAWINGS

FIG. 1 is a circuit block diagram of an LED emergency light of the present invention.

FIG. 2 is a three-dimensional assembly view of the LED emergency light of the present invention.

FIG. 3 is a three-dimensional assembly view of another embodiment of the LED emergency light of the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

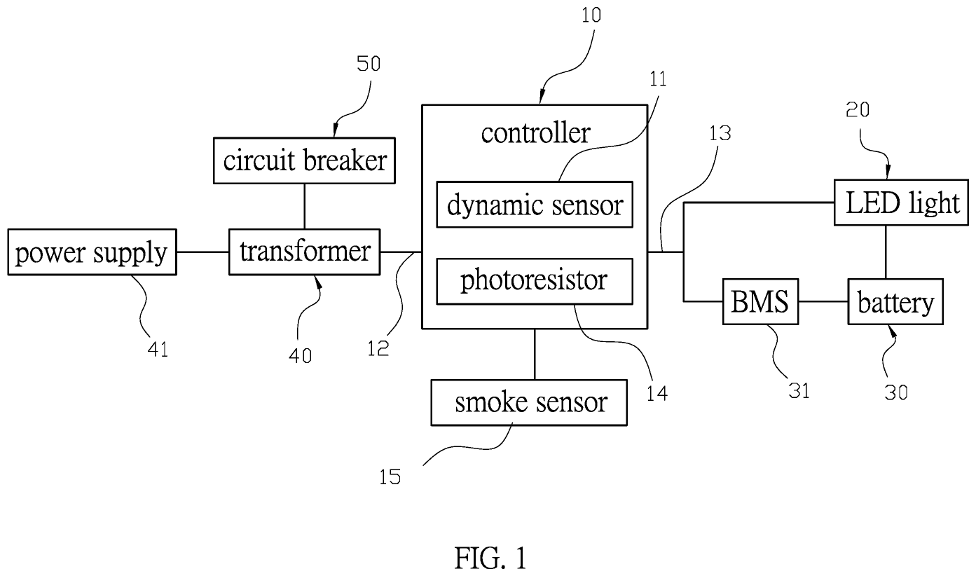

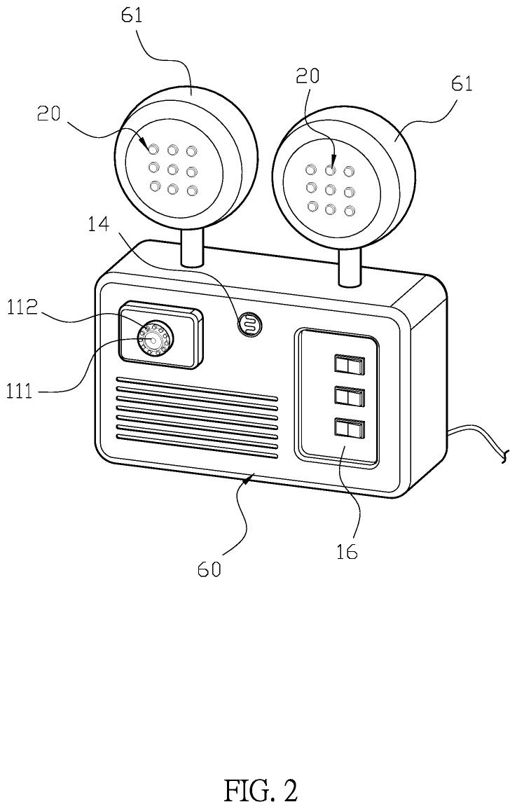

Referring to FIGS. 1 and 2, the present invention provides an LED emergency light which comprises a controller (10), an LED light (20), a battery set (30), a transformer (40), and a circuit breaker (50). The controller (10) is electrically connected to a dynamic sensor (11) which is configured to detect movements of objects in a preset detecting area. Moreover, the controller (10) is adapted to coordinate with the dynamic sensor (11) to generate on/off light signals. Also, the controller (10) has an input end (12) and an output end (13), and the dynamic sensor (11) has a camera (111) and at least an infrared lamp (112). The camera (111) is configured to capture movements of objects in the detecting area, and the infrared lamp (112) is adapted to provide additional illumination when the light in the detecting area is insufficient. Furthermore, the controller (10) is electrically connected to a photoresistor (14) which is configured to detect the light intensity of the detecting area. When the light in the detecting area is sufficient, the resistance of the photoresistor (14) is decreased, and the controller (10) is adapted to turn off and keep the LED light (20) off. The LED light (20) is electrically connected to the output end (13) of the controller (10), and the controller (10) is configured to send on/off light signals to the LED light (20), thereby controlling the on/off operation of the LED light (20). The battery set (30) is electrically connected to the output end (13) of the controller (10) at one end and electrically connected to the LED light (20) at the other end. Additionally, a battery management system (BMS) (31) electrically connected between the output end (13) of the controller (10) and the battery set (30) is configured to protect the battery set (30) from overcharging and over-discharging. The transformer (40) is electrically connected to the input end (12) of the controller (10) at one end and is electrically connected to a power supply (41) at the other end, and the power supply (41) is adapted to provide alternating current (AC) to the transformer (40). The circuit breaker (50) electrically connected to the transformer (40) is configured to enable electrical current to pass through the transformer (40) when AC is provided from the power supply (41), and the transformer (40) is adapted to convert AC to direct current (DC) so as to provide power to LED light (20) and to charge the battery set (30). In addition, the circuit breaker (50) is configured to interrupt electrical current passing through the transformer (40) when the power supply (41) does not provide AC, and the controller (10) is adapted to enable the battery set (30) to directly provide power to the LED light (20).

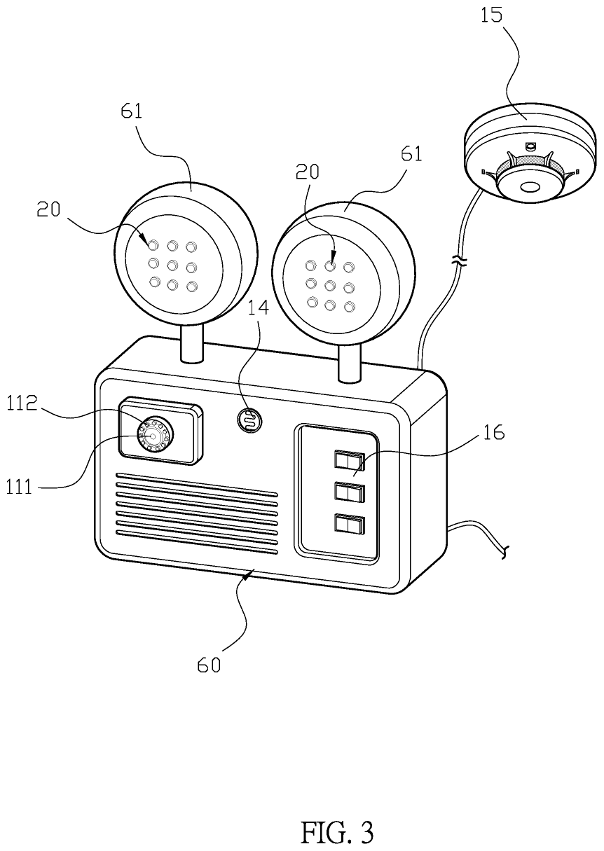

Referring to FIGS. 1 to 3, the controller (10), the battery set (30), the transformer (40) and the circuit breaker (50) are installed in a box (60), and at least a lamp cover (61) extended outwardly from the box (60) is adapted for installing the LED light (20). The camera (111) and the photoresistor (14) are respectively installed at a surface of the box (60), thereby detecting images and light intensity. Also, the controller (10) is electrically connected to a smoke sensor (15) through a wire which is extended out of the box (60) to enable the smoke sensor (15) to be faced downward after installed on a ceiling. The power supply (41) is electrically connected to mains electricity to provide AC to the transformer (40). The controller (10) is electrically connected to a control panel (16) which is installed on the surface of the box (60), and the control panel (16) is adapted to switch on/off operation of the power supply (41), the dynamic sensor (11), the smoke sensor (15) and the photoresistor (14). In actual application, AC from the power supply (41) is configured to flow through and be converted by the transformer (40) to DC, thereby charging the battery set (30). After the battery set (30) is fully charged, the controller (10) is adapted to stop charging the battery set (30), and the BMS (31) electrically connected between the battery set (30) and the controller (10) is configured to turn the battery set (30) into sleep mode, thereby protecting the battery set (30) from overcharging and over-discharging. In one embodiment, turning the battery set (30) into sleep mode is achieved through electronic circuits such as transistor and relay. When an object moves into the detecting area of the camera (111), the dynamic sensor (11) is configured to determine the move under camera (111) and send the signal of turn-on the light to the controller (10), and the controller (10) is adapted to enable the power supply (41) to provide power and turn on the LED light (20). Also, since the controller (10) is electrically connected to the photoresistor (14) which is configured to detect the light intensity of the detecting area, the LED light (20) is only turned on when the dynamic sensor (11) sends the signal of turn-on the light to the controller (10) and the light in the present area is insufficient. Similarly, when the object moves out of the detecting area of the camera (111), the controller (10) is configured to receive the signal of turn-off the light and then to the LED light (20) off.

Moreover, the prevent invention can further be added a control condition. The controller (10) is electrically connected to the smoke sensor (15) which is adapted to detect the smoke in the environment. When there is excessive smoke in the environment, the smoke sensor (15) is configured to send an alert signal to the controller (10) so as to enable the controller (10) to turn on the LED light (20) in this emergency situation, thereby achieving the function of early fire warning and lighting guide. The above-described situation is the use state of the present invention powered by the power supply (41). In case of power failure on the circumstances such as windstorm, fire, and earthquake, the power supply (41) will stop supply AC power, and at this moment, the circuit breaker (50) is configured to interrupt electrical current passing through the transformer (40) and to make the transformer (40) open circuited. Meanwhile, the controller (10) is configured to wake the battery set (30) by potential difference so as to enable the battery set (30) to directly power the LED light (20) and keep the LED light (20) turning on in emergency. Furthermore, when working, the photoresistor (14) is adapted to detect the light intensity of the detecting area and determine whether keeping the LED light (20) on or turning the LED light (20) off when the light in the detecting area is sufficient. Also, a user can selectively turn on/off the dynamic sensor (11) and the smoke sensor (15), and the battery set (30) is adapted to directly provide power to LED light (20) when emergency.

Comparing with conventional LED emergency light, the present invention is advantageous because: (i) the input end (12) of the controller (10) is electrically connected to the transformer (40) while the output end (13) thereof is electrically connected to the battery set (30) and the LED light (20), and also the LED light (20) is electrically connected to the battery set (30) while the transformer (40) is electrically connected to the power supply (41) and the circuit breaker (50), and the dynamic sensor (11) of the controller (10) is configured to detect movements of objects in the preset detecting area such that the LED light (20) can be powered by the power supply (41) in normal condition and be powered by the battery set (30) when the power supply (41) is cut, which simplifies the control circuit and provides lighting when detecting objects and when emergency; (ii) in case that the power supply (41) stops supplying AC power, the circuit breaker (50) is configured to interrupt electrical current passing through the transformer (40) and to make the transformer (40) open circuited, and the controller (10) is configured to wake the battery set (30) so as to enable the battery set (30) to directly power the LED light (20); (iii) when the transformer (40) is open circuited, the battery set (30) has no need to provide power to the transformer (40), and the dynamic sensor (11) is selectively turned on, which extends the service time of the battery set (30); (iv) after the battery set (30) is fully charged, the controller (10) is adapted to stop charging the battery set (30), and the BMS (31) electrically connected between the battery set (30) and the controller (10) is configured to turn the battery set (30) into sleep mode; and (v) with the dynamic sensor (11), the LED light (20) is turned on when an object passing through the detecting area, which enables a user to ensure the expected function of the LED light (20) at any time.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. An LED emergency light comprising:
a controller electrically connected to a dynamic sensor which is configured to detect movements of objects in a preset detecting area; the controller adapted to coordinate with the dynamic sensor to generate on/off light signals, and the controller having an input end and an output end;
an LED light electrically connected to the output end of the controller, and the controller configured to send on/off light signals to the LED light, thereby controlling the on/off operation of the LED light;
a battery set electrically connected to the output end of the controller at one end and electrically connected to the LED light at the other end;
a transformer electrically connected to the input end of the controller at one end and electrically connected to a power supply at the other end, and the power supply adapted to provide alternating current (AC) to the transformer; and
a circuit breaker, which is electrically connected to the transformer, configured to enable electrical current to pass through the transformer when AC provided from the power supply, and the transformer adapted to convert AC to direct current (DC) so as to provide power to LED light and to charge the battery set; the circuit breaker configured to interrupt electrical current passing through the transformer when the power supply adapted to not provide AC, and the controller configured to enable the battery set to directly provide power to the LED light.

2. The LED emergency light of claim 1, wherein the dynamic sensor has a camera and at least an infrared lamp, and the camera is configured to capture movements of objects in the detecting area, and the infrared lamp is adapted to provide additional illumination when the light in the detecting area is insufficient.

3. The LED emergency light of claim 1, wherein a battery management system (BMS) electrically connected between the output end of the controller and the battery set is configured to protect the battery set from overcharging and over-discharging.

4. The LED emergency light of claim 1, wherein the controller is electrically connected to a photoresistor which is configured to detect the light intensity of the detecting area.

5. The LED emergency light of claim 1, wherein the controller, the battery set, the transformer and the circuit breaker are installed in a box, and at least a lamp cover extended outwardly from the box is adapted for installing the LED light.

6. The LED emergency light of claim 5, wherein the controller is electrically connected to a smoke sensor through a wire which is extended out of the box.

7. The LED emergency light of claim 5, wherein the controller is electrically connected to a control panel which is installed on a surface of the box.
